(19) United States
(12) Patent Application Publication
(10) Pub. No.: US 2012/0072483 A1
(43) Pub. Date: Mar. 22, 2012

(54) METHODS AND APPARATUS FOR CONVERTING AND TRANSMITTING DATA

(75) Inventors: David Jordan Pflueger, Golden, CO (US); George Stepanenko, Naples, FL (US); Conley Matthew Haynes, Atlanta, GA (US); Eric Howard Klein, Miami, FL (US)

(73) Assignee: DEVICELYNX INCORP., Moreland, GA (US)

(21) Appl. No.: 13/234,643

(22) Filed: Sep. 16, 2011

Related U.S. Application Data
(60) Provisional application No. 61/384,569, filed on Sep. 20, 2010.

(51) Int. Cl. G06F 15/16; H04W 4/00

(52) U.S. Cl. 709/203

(57) ABSTRACT

Apparatus and methods for facilitating converting the mobile data collection device serial port output to a wireless transmission to an application server via a serial port to wireless converter. For example, the mobile data collection device may be a medical instrument used in a hospital environment. The application server in turn provides the data from the mobile device and it's operator to the user or user specified persons through an enterprise system interface.

### CROSS-REFERENCE TO RELATED APPLICATIONS

This application claims priority to the following application: U.S. Provisional Application No. 61/384,569, titled “Methods and Systems for Converting and Transmitting Data,” filed on Sep. 20, 2010, which is incorporated by reference herein in its entirety.

### BACKGROUND OF THE INVENTION

1. Field of the Invention

Aspects of the present invention relate to methods and systems for data manipulation, conversion and transmission for mobile devices without wireless transmission capabilities. More specifically, the present invention relates to adding wireless transmission capability to mobile devices making them accessible/locatable at anytime and anywhere.

2. Background of the Related Art

As wireless connectivity technology is becoming more pervasive, there is a move to implement wireless-based mobile devices. The new wireless mobile devices are very costly compared to using existing mobile devices with existing serial port(s), but adding a wireless adapter to provide wireless capability. Thus, there is a need in the art for methods and systems to convert the serial port data output to a wireless transmission using a wireless adapter.

### SUMMARY

Aspects of the present invention include methods and associated apparatuses that, among other things, facilitate converting the Mobile Data Collection Device (MDCD) serial port output to a wireless transmission to an application server via a serial port to wireless converter (SPWC). The application server in turn provides the data from the mobile device and its operator to the user or user specified persons through an enterprise system interface. Users may receive feedback from the MDCD at anytime and/or in multiple locations via the enterprise system interface. For example, the MDCD may be a medical device used in a hospital environment.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example communication system in accordance with aspects of the present invention;

FIG. 2 illustrates an example communication system for use in an hospital environment in accordance with an aspect of the present invention;

FIG. 3 illustrates an example flow diagram of a method for converting serial port output to a wireless transmission in accordance with an aspect of the present invention;

FIG. 4 illustrates an example flow diagram of a method for performing data analysis in accordance with an aspect of the present invention; and

FIG. 5 illustrates various features of an example computer system for use in conjunction with aspects of the present invention.

### DETAILED DESCRIPTION

Aspects of the present invention include apparatuses and methods for collecting and presenting data from a Mobile Data Collection Device (MDCD) with serial port(s) without wireless transmission capability, by using a Serial Port to Wireless Converter (SPWC) to enable transfer of the data wirelessly to an application server. In one aspect, the SPWC may include a mobile device having an embedded reprogrammable microprocessor to convert the serial port input(s) to Wireless Converter processable format to thereby enable wireless transfer of the data to the application server, in order to provide data from the MDCD to the user or the user specified persons, through an enterprise system, for example. In addition to the MDCD data, the SPWC may collect additional information and data from additional data sources and combine them in the application server for presentation to the enterprise system.

In the following description, numerous details are set forth to provide a more thorough explanation of aspects of the present invention. It will be apparent, however, to one skilled in the art, that various aspects of the present invention may be practiced without these specific details. In other instances, well-known structures and devices are shown in block diagram form, rather than in detail, in order to avoid obscuring thereof.

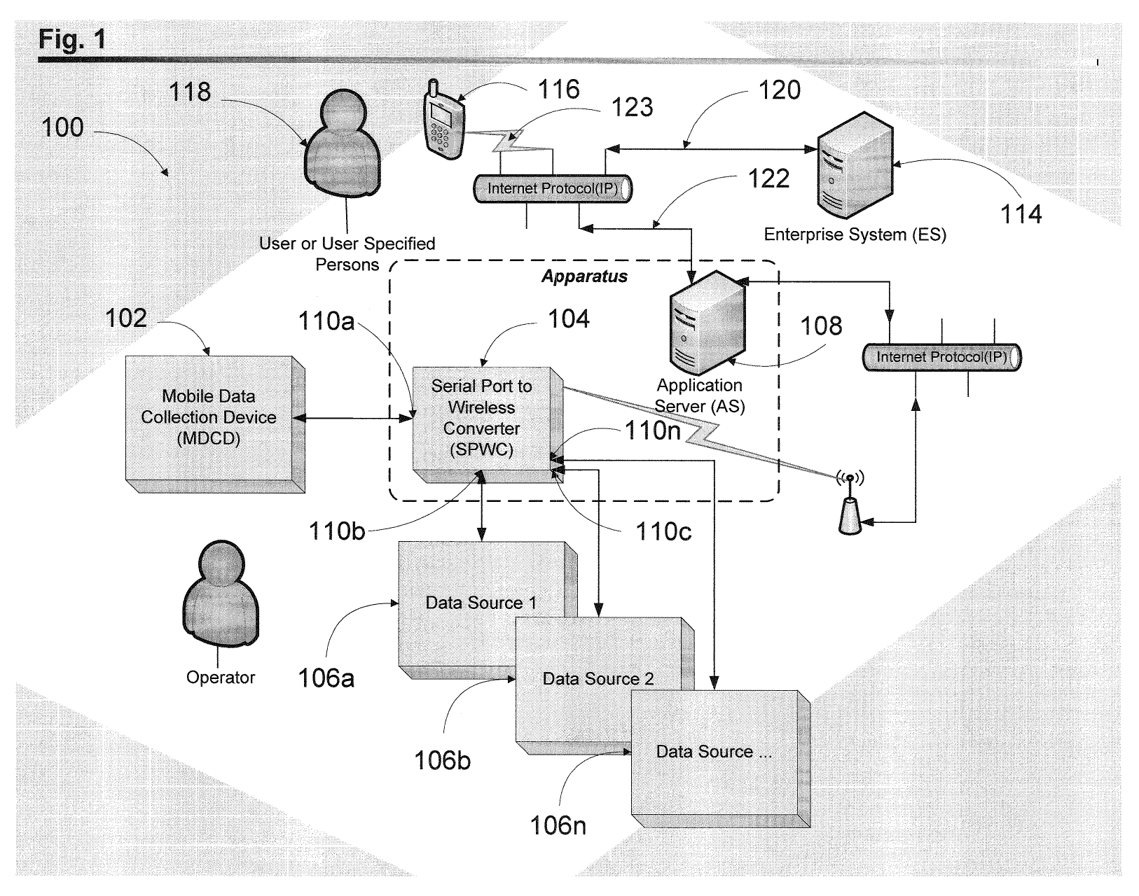

Referring now to FIG. 1, illustrated is an example communication system 100 to collect data wirelessly from the Mobile Data Collection Device (MDCD) 102 and provide access to the collected data at any time and/or anywhere through enterprise system 114. For example, a user 118 may access the data on enterprise system 114 via wireless device 116. Wireless device may include any suitable mobile, portable computing or communications device, such as a cellular device, coupled to a server 108, such as a PC, minicomputer, mainframe computer, microcomputer, or other device having a processor and a repository for data and/or connection to a repository for data, via, for example, an access network, such as the Internet or an intranet, and couplings 120, 122, 123. The couplings 120, 122, 123 include, for example, wired, wireless, or fiberoptic links.

For example, wireless device may include a cellular telephone, a navigation system, a global positioning system (GPS), a computing device, a camera, a personal digital assistant (PDA), personal computers (PCs), minicomputers, mainframe computers, microcomputers, telephonic devices, or other handheld device having wireless connection capability, among other devices. It should also be appreciated that enterprise system 114 may comprise a server and/or computing devices that may include, for example, any suitable mobile or fixed computing device connected to a network.

System 100 may include a serial port to wireless converter (SPWC) 104 that receives data from MDCD 102 and one or more data sources 106a-106n via one or more serial ports 110a-110n. Serial ports 110a-110n may include but are not limited to: Current Loop, RS232, RS422, RS423, RS485, IEEE488, and USB. It should be appreciated that the serial ports 110a-110n may be the same type of serial ports, e.g., each serial port is a RS232 port or different types of serial ports, e.g., one serial port is a RS232 port while another serial port is a USB port. Thus, SPWC 104 may have multiple data port inputs, one port 110a for mobile device 102, and other ports 110b-110n for the data sources 106a-106n.

SPWC 104 may include, for example, a microprocessor which interprets the received data from the mobile device (MDCD) 102 and data sources 106a-106n, converts the data to command standard format, and transmits the data through a wireless network to application server 108. SPWC 104 may provide, for example, two outputs, such as a LCD display for an operator of SPWC 104 and/or a wireless transmitter to transfer the data to the application server 108.

In an aspect, server 108 may forward the received data from SPWC 104 to an enterprise system 114. Enterprise system 114 may include one or more user interface features, which present the received data from SPWC 104 to one or more users and/or assist users through various steps or acts of tracking and monitoring the received data. The user interface features may include a series of interactive interfaces and other database or repository interfaces that may allow users to verify and monitor the received data. For example, the user interface features may allow users to receive and/or review alerts relating to the data, search for specific devices that collected the data, and/or run reports on the data, among other functionality. In an aspect, the user may access enterprise system 114 via one or more wireless devices 116. Thus, users may receive feedback from the MDCD at anytime and/or in multiple locations via the enterprise system interface.

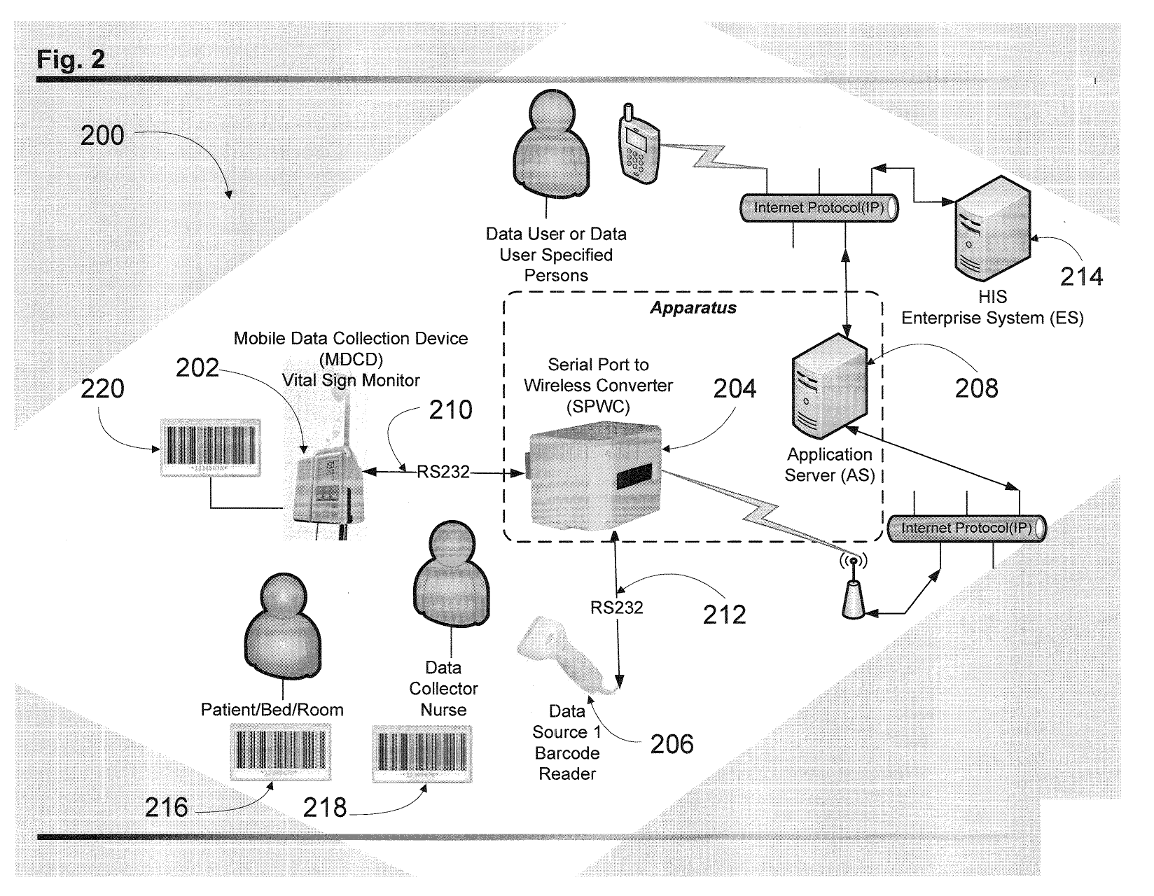

Referring now to FIG. 2, illustrated is an example communication system 200 for use in a hospital environment in accordance with an aspect of the present invention. The mobile data collection device 202 is illustrated as a vital sign monitor connected to the SPWC 204 through the serial port cable 210, e.g., RS232. The SPWC's 204 additional serial port is connected to a barcode reader 206 via serial port cable 212, e.g., RS232.

In an aspect, SPWC 204 may include a processor that is Wi-Fi enabled. The processor may decode the bit-stream received from the medical device 202, parse the bit-stream, add a time/date stamp to the data, and transmit the data to the application server 208. The application server 208 may translate the data into human readable form from an on-board library, and wrap the message into either a HL7or XML package for its submission to a hospital information system 214. In addition, the processor may also parse the barcode reader data and translate the data to either a HL7 or XML package for its submission to the hospital information system 214.

In the illustrated example, the operator of the SPWC 204 is a nurse. The nurse may use the barcode reader 206 to add patient, bed number and room number 216, for example, to the medical device's information. For example, the nurse may scan the barcode on the patient ID bracelet 216, the medical device 220, and the medication being administered to the patient, creating a pairing of these data elements, along with the location of the data collection and a time/date stamp of the data collection. The nurse may verify the transaction on a workstation web browser or smart phone to confirm it. Alarms or other messages may optionally be transmitted to the nurse or to Bio-Med in the case of a device malfunction. In relation to HIPAA regulations and security, for example, commonly observed patient privacy and networking security protocols may be implemented in accordance with aspects of the present invention.

The SPWC 204 communicates some or all of the date/time stamped data wirelessly to the application server 208. Application server 208 transfers the packaged data to the hospital information system 214. References to details in this example are not intended to limit the scope of the claims.

Advantages of connecting existing mobile medical devices to the hospital information system in this example include improving accuracy, efficiency and compliance of medical information captured by the mobile medical devices. In addition, by extending the useful life of existing medical devices, hospitals can post-pone the investment in expensive next generation medical devices to a time that is more financially desirable.

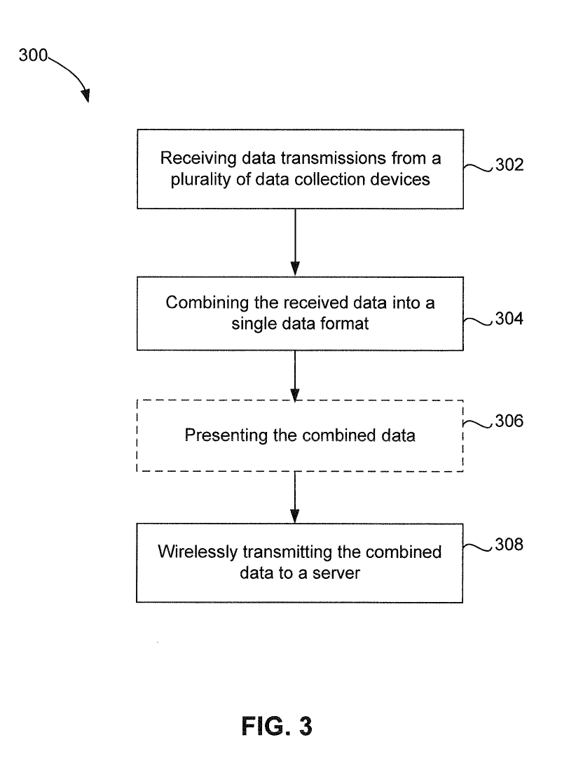

Referring now to FIG. 3, illustrated is a method 300 for providing wireless transmission capabilities to received data from one or more devices without wireless transmission capabilities, in accordance with an aspect of the present invention. The method may include receiving data from a plurality of data collection devices 302. For example, a wireless data converting device, such as a SPWC 204 (FIG. 2), may receive input via two different RS232 feeds 210, 212 (FIG. 2) from non wireless data collection devices, such as a mobile data collection device 202 (FIG. 2) and/or other data sources, e.g., barcode reader 206 (FIG. 2).

In one example use case, the received data may relate to medical data associated with a patient. The mobile data collection device may be, but is not limited to, a medical instrument that captures and records medical data from a patient, such as a vital sign monitor. In addition, the barcode reader may be used, for example, to capture patient identification (ID) information, the device ID information, and a medical practitioner ID to identify the medical practitioner who collected and/or verified the captured medical data associated with the patient. Thus, the data received at the SPWC may include, for example, a patient ID, a nurse ID, and the medical data (e.g., blood pressure, pulse, oxygen level) for the patient recorded by the medical instrument. It should be noted that the medical instrument may be moved to another location and record a different patient's medical data. In addition, a different medical instrument may be connected to a patient and the data transmitted to the SPWC. Therefore, the SPWC may interface with multiple data collection devices and receive inputs from a variety of data sources.

The method may also include combining the received data into a single data format 304. In an aspect, the SPWC may combine the received data into an order and/or a standard format. For example, the SPWC may order the received data as follows: “<Nurse ID>, <Patient ID>, <Device ID>, <Medical Data>.” It should be noted that the received data may be combined and/or placed in an order in a variety of manners.

Optionally, the method may include presenting the combined data 306. In an aspect, the SPWC may have an interface, such as a display, in which the combined data may be presented to a user, such as the nurse who captured the medical data associated with the patient. The nurse may use the presented information to verify that the received data is accurate. For example, if the medical data is inaccurate, such as exceeds a threshold limit and/or is below a threshold limit (e.g., a temperature is too high and/or too low), an alert may be generated and/or presented and the nurse may use this information to gather additional medical data before verifying the captured medical data is accurate. In addition, if the ID for the patient and/or nurse is incorrect, the nurse may rescan the IDs for the patient and/or nurse before verifying that the received data is correct.

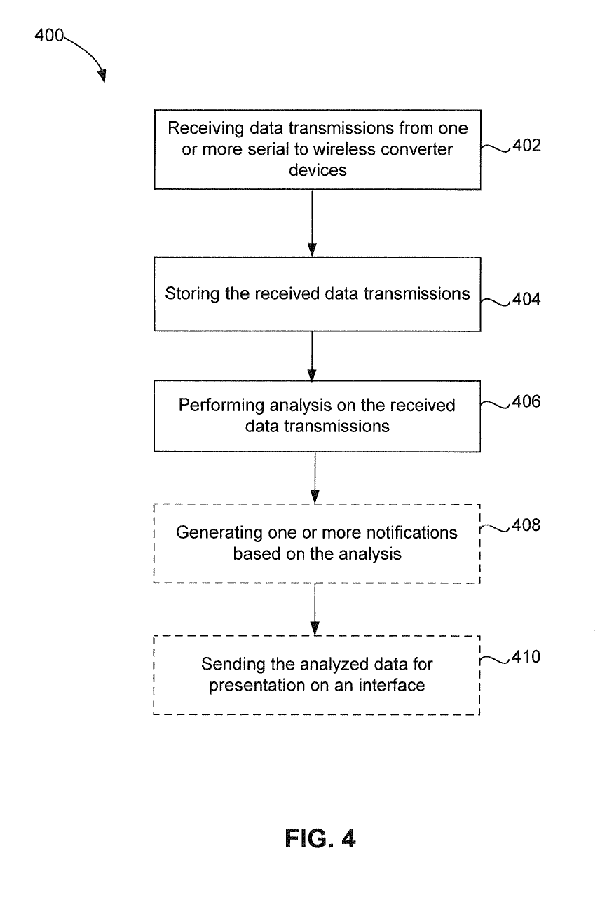

The method may further include wirelessly transmitting the combined data to a server 308. In an aspect, the SPWC may wirelessly transmit the combined data to a server, such as application server 208 (FIG. 2). It should be noted that an identifier of the SPWC may also be transmitted along with the combined data to the server to identify the source of the transmitted data, e.g., the SPWC. The server may receive the data and perform additional processing on the data, as discussed in conjunction with FIG. 4 below.

Referring now to FIG. 4, illustrated is a method 400 for performing data analysis. The method may include receiving one or more data transmission from one or more serial to wireless converter devices 402. For example, server 208 (FIG. 2) may receive one or more data transmissions from SPWC 204 (FIG. 2) as discussed above in FIG. 3.

The method may also include storing the received data transmissions 406. For example, server 208 may store and manage data received from multiple medical devices in a single location. For example, the server may store the data based upon the time and/or date the data was captured. In another example, the server may store the data based upon one or more the following IDs: the device ID, the patient ID, the medical provider ID and/or the SPWC ID. It should be noted that the above are representative examples of how the data may be stored and that the server may store the data in a variety of manners.

The method may further include performing analysis on the received data transmissions 406. Analysis may include, but is not limited to, running reports on the data (e.g., date and time data was captured), performing searches on the data (e.g., searching for a particular medical device that captured the data), comparing the received data with data threshold levels (e.g., ensuring the data is correct and free from errors and malfunctions), and removing confidential information from the data (e.g., patient identification data), among other forms of data analysis.

The method may optionally include generating one or more notifications and/or alerts based on the analysis 408. In an aspect, the notifications and/or alerts may include, for example, activating an alarm on a user's device and/or sending message (e.g., a short message service (SMS) message, an e-mail message, or a voice message) to a user to notify the user that an error may have occurred with the captured data. Information sent with the alert may include, for example, the identification of the medical device that collected the medical data, the identification of the nurse who operated the medical device, and/or the identification of the patient, among other information. Thus, the user can use the alert to identify when and/or where the data was captured.

The method may also include sending the analyzed data for presentation on an interface 410. For example, server 208 may send a report, such as the time and/or date the data was collected, for presentation on the hospital information system 214 (FIG. 2). The generated reports may include various forms of reports or presentations. It should be appreciated that the reports may be generated for an individual medical device or patient or a group of medical devices or patients. The type of report to be generated may be selected by a user from a drop-down menu or entered in an appropriate field by a user, for example.

Benefits, among others, of the this example may include: accurate and timely data capture, timely notice of device errors and malfunctions, reduced search time for medical devices, and common platform to manage all mobile medical devices.

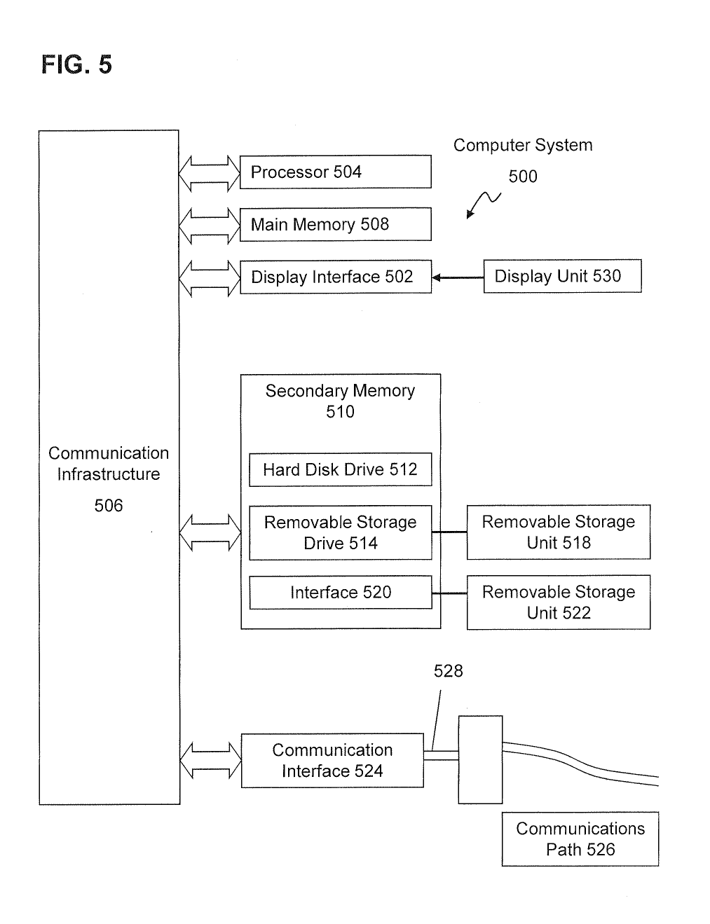

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software aspects are described in terms of this exemplary computer system. After reading this description, it will become apparent to a person skilled in the relevant art(s) how to implement aspects hereof using other computer systems and/or architectures.

Computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data.

Alternative aspects of the present invention may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 570, and signals 528. These computer program products provide software to the computer system 500. Aspects of the invention are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features in accordance with aspects of the present invention, as discussed herein. In particular, the computer programs, when executed, enable the processor 510 to perform the features in accordance with aspects of the present invention. Accordingly, such computer programs represent controllers of the computer system 500.

In an aspect of the present invention where the invention is implemented using software, the software may be stored in a computer program product and loaded into computer system 500 using removable storage drive 514, hard drive 512, or communications interface 520. The control logic (software), when executed by the processor 504, causes the processor 504 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, implementation occurs using a combination of both hardware and software.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for converting data transmissions, the method comprising:
receiving data transmissions, at a converter device, from a plurality of data collection devices, wherein the data collection devices are coupled to the converter device via one or more cables connected to one or more serial ports on the converter device;
combining the received data into a single data format; and
wirelessly transmitting the combined data to a server.

2. The method of claim 1, wherein the cables are RS232 cables.

3. The method of claim 1, further comprising:
presenting the combined data on a display.

4. The method of claim 3, wherein the presented combined data comprises an identification of the data collection devices and an identification of an operator of the data collection devices.

5. The method of claim 3, further comprising:
receiving an alert associated with the received data; and
presenting the alert.

6. The method of claim 5, wherein the alert comprises one of a short message service (SMS) message, an e-mail message, a voice message, and an alarm.

7. The method of claim 1, wherein combining the received data further comprises:
parsing the received data; and
adding a date and time stamp to the data.

8. The method of claim 1, wherein one of the plurality of data collection devices comprises a medical instrument.

9. The method of claim 1, wherein one of the plurality of data collection devices comprises a barcode reader.

10. An apparatus, comprising:
a plurality of serial ports configured to receive data transmissions from a plurality of data collection devices;
a processor configured to combine the received data into a single data format; and
a transmitter configured to wirelessly transmit the combined data to a server,
wherein the plurality of data collection devices are coupled via one or more cables connected to the one or more serial ports.

11. The apparatus of claim 10, wherein the cables are RS232 cables.

12. The apparatus of claim 10, further comprising:
an interface configured to present the combined data.

13. The apparatus of claim 12, wherein the presented combined data comprises an identification of the data collection devices and an identification of an operator of the data collection devices.

14. The apparatus of claim 12, wherein the processor is further configured to
receive an alert associated with the received data transmissions; and
forward the alert for presentation on the interface.

15. The apparatus of claim 14, wherein the alert comprises one of a short message service (SMS) message, an e-mail message, a voice message, and an alarm.

16. The apparatus of claim 10, wherein the processor is further configured to parse the received data and add a date and time stamp to the data.

17. The apparatus of claim 10, wherein one of the plurality of data collection devices comprises a medical instrument.

18. The apparatus of claim 10, wherein one of the plurality of data collection devices comprises a barcode reader.

19. A system for converting data transmissions, the system comprising:
a processor;
a user interface functioning via the processor; and
a repository accessible by the processor;
wherein data transmissions are received, at a converter device, from a plurality of data collection devices via one or more cables connected to one or more serial ports on the converter device;
wherein the received data is combined into a single data format; and
wherein the combined data is wirelessly transmitted to a server.

20. A computer product comprising a computer readable medium having control logic stored therein for causing a computer to convert data transmissions, the control logic comprising:
first computer readable program code means for receiving data transmissions from a plurality of data collection devices;
second computer readable program code means for combining the received data into a single data format; and
third computer readable program code means for wirelessly transmitting the combined data to a server.
